(19) United States
(12) Patent Application Publication
(10) Pub. No.: US 2013/0028690 A1
(43) Pub. Date: Jan. 31, 2013

(54) APPARATUS AND METHOD FOR TREATING SUBSTRATE

(71) Applicants: Joo Jib Park, Asan-si (KR); Woo Young Kim, Cheonan-si (KR); Oh Jin Kwon, Cheonan-si (KR); Boong Kim, Cheonan-si (KR)

(72) Inventors: Joo Jib Park, Asan-si (KR); Woo Young Kim, Cheonan-si (KR); Oh Jin Kwon, Cheonan-si (KR); Boong Kim, Cheonan-si (KR)

(73) Assignee: SEMES CO., LTD., Cheonan-si (KR)

(21) Appl. No.: 13/559,857

(22) Filed: Jul. 27, 2012

(30) Foreign Application Priority Data
Jul. 29, 2011 (KR) 10-2011-0076238
Dec. 27, 2011 (KR) 10-2011-0143129

(51) Int. Cl. B65G 47/74; A47B 81/00

(52) U.S. Cl. 414/222.01; 312/294; 312/319.5; 312/31; 414/806

(57) ABSTRACT

Provided are an apparatus and method for treating a substrate. More particularly, an apparatus and method for treating a substrate through a supercritical process are provided. The apparatus includes a housing having an entrance in a side thereof and providing a space for performing a process, a door for opening and closing the entrance, and a support member disposed on the door to receive a substrate thereon.

### CROSS-REFERENCE TO RELATED APPLICATIONS

This U.S. non-provisional patent application claims priority under 35 U.S.C. §119 of Korean Patent Application Nos. 10-2011-0076238, filed on Jul. 29, 2011, and 10-2011-0143129, filed on Dec. 27, 2011, the entire contents of which are hereby incorporated by reference.

### BACKGROUND OF THE INVENTION

The present invention disclosed herein relates to an apparatus and method for treating a substrate, and more particularly, to an apparatus and method for treating a substrate through a supercritical process.

Semiconductor devices are manufactured by forming circuit patterns on a substrate through various processes such as a photolithography process. During such processes, contaminants such as particles, organic contaminants, and metallic impurities are generated, which cause defects on a substrate and affect the yield of semiconductor device manufacturing processes. Therefore, cleaning processes are included in semiconductor device manufacturing processes to remove such contaminants.

Generally, a cleaning process is performed by removing contaminants from a substrate using a chemical, washing the substrate using deionized water (DI water), replacing the DI water with an organic solvent having low surface tension such as isopropyl alcohol (IPA), and evaporating the organic solvent. However, semiconductor devices having fine circuit patterns are not satisfactorily dried, and the fine circuit patterns may easily collapse even by low surface tension of an organic solvent during a drying process.

Thus, as a drying process, the use of a supercritical drying process is increased, in which a supercritical fluid is used to dry semiconductor devices having a line width of about 30 nm or lower. Supercritical fluids mean any substance being at a temperature and pressure above its critical point and having both the gas and liquid properties. Supercritical fluids are outstanding in diffusion ability, permeation ability, and dissolving other substrates, and have little surface tension. Thus, supercritical fluids can be usefully used for dying substrates.

However, a process chamber for performing a supercritical process has a large foot print to maintain a high-pressure supercritical state, and thus the substrate throughput thereof is low.

### SUMMARY OF THE INVENTION

The present invention provides an apparatus and method for treating a substrate through a supercritical process using a process chamber having high spatial efficiency.

The present invention also provides an apparatus and method for treating a substrate in a high pressure condition.

The present invention is not limited thereto. Other features and spirit of the present invention will be apparently understood by those skilled in the art through the following description and accompanying drawings.

Embodiments of the present invention provide apparatuses for treating a substrate.

The apparatuses include: a housing including an entrance in a side thereof and providing a space for performing a process; a door for opening and closing the entrance; and a support member disposed on the door to receive a substrate thereon.

In some embodiments, the apparatuses may further include a pressing member configured to apply a force to the door in a direction perpendicular to the side of the housing, wherein the door may be movable by the pressing member in the direction perpendicular to the side of the housing for closing or opening the housing.

In other embodiments, the support member may be placed in or outside the housing as the door is moved.

In still other embodiments, the pressing member may include: a cylinder coupled to the housing; and a rod connected to the cylinder and the door, the rod being movable by the cylinder in the direction perpendicular to the side of the housing.

In even other embodiments, the support member may have a plate shape extending from a side of the door facing the entrance in a direction in which the door is movable, and a hole may be formed in the support member to receive the substrate.

In yet other embodiments, the apparatuses may further include: a heating member configured to heat an inside of the housing; a supply port configured to supply a supercritical fluid to the housing; and an exhaust port configured to discharge the supercritical fluid from the housing.

In further embodiments, the supply port may include: an upper supply port disposed at an upper surface of the housing; and a lower supply port disposed at a lower surface of the housing.

In other embodiments of the present invention, there are provided apparatuses for treating a substrate, the apparatuses including: a transfer chamber configured to transfer a substrate; and a process chamber disposed at a side of the transfer chamber, the process chamber including a housing having an entrance in a side thereof and providing a space for performing a process, a door for opening and closing the entrance, and a support member disposed on the door to receive the substrate, wherein when viewed from a topside, the side of the transfer chamber and the side of the housing are perpendicular.

In some embodiments, the apparatuses may further include a pressing member configured to apply a force to the door in a direction perpendicular to the side of the housing, wherein the door may be movable by the pressing member in the direction perpendicular to the side of the housing for closing or opening the housing.

In other embodiments, the pressing member may include: a cylinder coupled to the housing; and a rod connected to the cylinder and the door, the rod being movable by the cylinder in the direction perpendicular to the side of the housing.

In still other embodiments, the support member may have a plate shape extending from a side of the door facing the entrance in a direction in which the door is movable, and a hole may be formed in the support member to receive the substrate.

In even other embodiments, the process chamber may be provided in plurality, and the plurality of process chambers may be arranged in a line on the side of the transfer chamber along a direction in which the door is movable.

In yet other embodiments, the process chamber may be provided in plurality, and the plurality of process chambers may be vertically stacked.

In further embodiments, the apparatuses may further include: a heating member configured to heat an inside of the housing; a supply port configured to supply a supercritical fluid to the housing; and an exhaust port configured to discharge the supercritical fluid from the housing.

In still further embodiments, the supply port may include: an upper supply port disposed at an upper surface of the housing; and a lower supply port disposed at a lower surface of the housing.

In still other embodiments of the present invention, there are provided methods for treating a substrate.

The methods include: placing a substrate on a support member disposed on a door; moving the door to a side of a housing in which an entrance is formed, so as to place the support member in the housing and close the housing; performing a process on the substrate placed in the housing; and moving the door away from the side of the housing so as to place the support member outside the housing and open the housing.

In some embodiments, in the moving of the door to and away from the side of the housing, a rod coupled to the door may be moved in a direction perpendicular to the side of the housing by a cylinder connected to the rod and the housing.

In other embodiments, in the performing of the process, a force greater than a force generated by a pressure different between inner and outer sides of the housing may be applied from a pressing member to the door so as to keep the housing in a closed state.

In still other embodiments, the support member may have a plate shape extending from a side of the door facing the entrance in a direction perpendicular to the side of the door, and a hole may be formed in the support member to receive the substrate, wherein in the performing of the process, a supercritical fluid may be supplied to a topside and a rear side of the substrate through an upper supply port formed in an upper side of the housing and a lower supply port formed in a lower side of the housing.

In even other embodiments, in the performing of the process, the supercritical fluid may be supplied through the lower supply port before the supercritical fluid is supplied through the upper supply port.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a phase diagram of carbon dioxide;

FIG. 2 is a plan view illustrating a substrate treating apparatus according to an embodiment of the present invention;

FIG. 3 is a sectional view illustrating the substrate treating apparatus;

FIG. 4 is a sectional view illustrating a first process chamber depicted in FIG. 2, according to an embodiment of the present invention;

FIGS. 5 and 6 are perspective views illustrating a second process chamber depicted in FIG. 2, according to an embodiment of the present invention;

FIG. 7 is a sectional view illustrating the second process chamber depicted in FIG. 2;

FIG. 8 is a sectional view illustrating a modification example of the second process chamber depicted in FIG. 2;

FIG. 9 is a view in which such second process chambers as depicted in FIG. 2 are stacked;

FIG. 10 is a flowchart for explaining a substrate treating method according to an embodiment of the present invention;

FIG. 11 is a flowchart for explaining another embodiment of the substrate treating method;

FIGS. 12 through 13 are views for explaining the substrate treating method of FIG. 11.

### DETAILED DESCRIPTION OF PREFERRED EMBODIMENTS

In the following description, terms and drawings are used for explaining embodiments of the present invention while not limiting the present invention.

Known techniques used in the present invention but not related to the concept of the present invention will not be explained in detail.

Hereinafter, a substrate treating apparatus 100 will be described according to exemplary embodiments of the present invention.

The substrate treating apparatus 100 may be used to perform a supercritical process for treating a substrate (S) using a supercritical fluid as a process fluid.

The term “substrate (S)” is used herein to denote any substrate used to manufacture a product such as a semiconductor device and a flat panel display (FPD) in which circuit patterns are formed on a thin film. Examples of substrates (S) include wafers such as silicon wafers, glass substrates, and organic substrates.

The term “supercritical fluid” means any substance having both the gas and liquid characteristics because the phase of the substance is in a supercritical state above its critical temperature and pressure. A supercritical fluid has molecular density close to that of liquid and viscosity close to that of gas, and is thus outstanding in diffusion ability, permeation ability, and dissolving other substances. Therefore, a supercritical fluid is advantageous in chemical reaction. In addition, a supercritical fluid has little surface tension, and thus applies little interfacial tension to microstructures.

Supercritical processes are performed using the properties of a supercritical fluid, and examples of supercritical processes include a supercritical drying process and a supercritical etch process. Hereinafter, a supercritical process will be explained based on a supercritical drying process. Although the following explanation is given based on a supercritical drying process for conciseness of the explanation, the substrate treating apparatus 100 can be used for performing other supercritical processes.

A supercritical drying process may be performed to dissolve an organic solvent remaining on circuit patterns of a substrate (S) in a supercritical fluid and dry the substrate (S). In this case, satisfactory dry efficient may be obtained while preventing pattern collapse. A substance miscible with an organic solvent may be used as a supercritical fluid in a supercritical drying process. For example, supercritical carbon dioxide (scCO₂) may be used as a supercritical fluid.

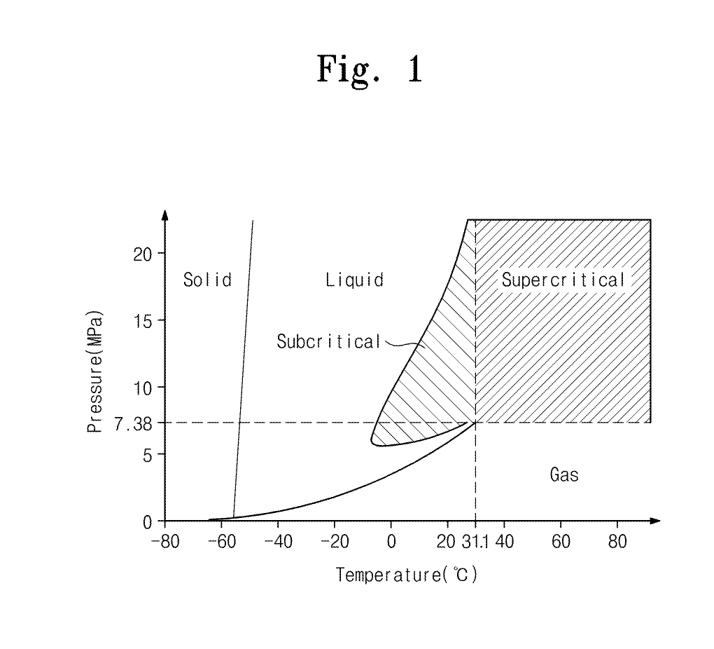

FIG. 1 is a phase diagram of carbon dioxide.

Since carbon dioxide has a relatively low critical temperature of 31.1° C. and critical pressure of 7.38 Mpa, it is easy to make carbon dioxide supercritical and control the phase of carbon dioxide by adjusting temperature and pressure. In addition carbon dioxide is inexpensive. In addition, carbon dioxide is nontoxic, harmless, nonflammable, and inert, and has a diffusion coefficient about ten to hundred times the diffusion coefficient of water or other organic solvents to rapidly permeate and replace an organic solvent. Furthermore, carbon dioxide has little surface tension. That is, the properties of carbon dioxide are suitable for drying a substrate (S) having fine patterns. In addition, carbon dioxide obtained from byproducts of various chemical reactions can be reused, and carbon dioxide used in a supercritical drying process can be separated from an organic solvent by vaporizing the carbon dioxide for reusing the carbon dioxide. That is, carbon dioxide is environmentally friendly.

Hereinafter, the substrate treating apparatus 100 will be described according to an embodiment of the present invention. The substrate treating apparatus 100 of the embodiment may be used to perform a cleaning process including a supercritical drying process.

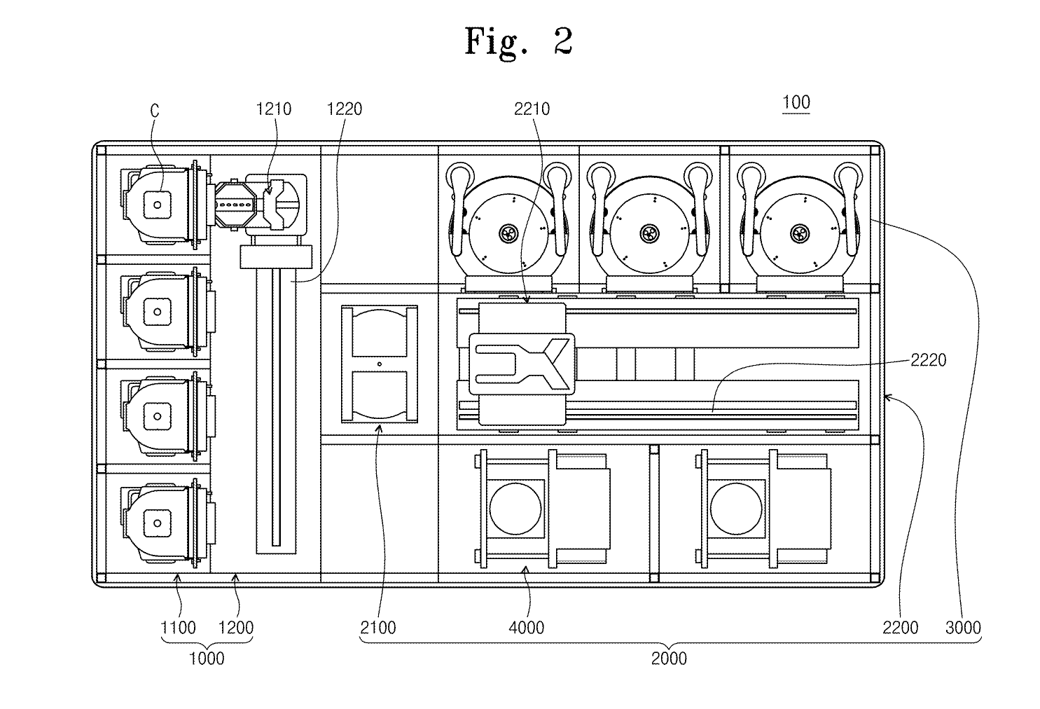

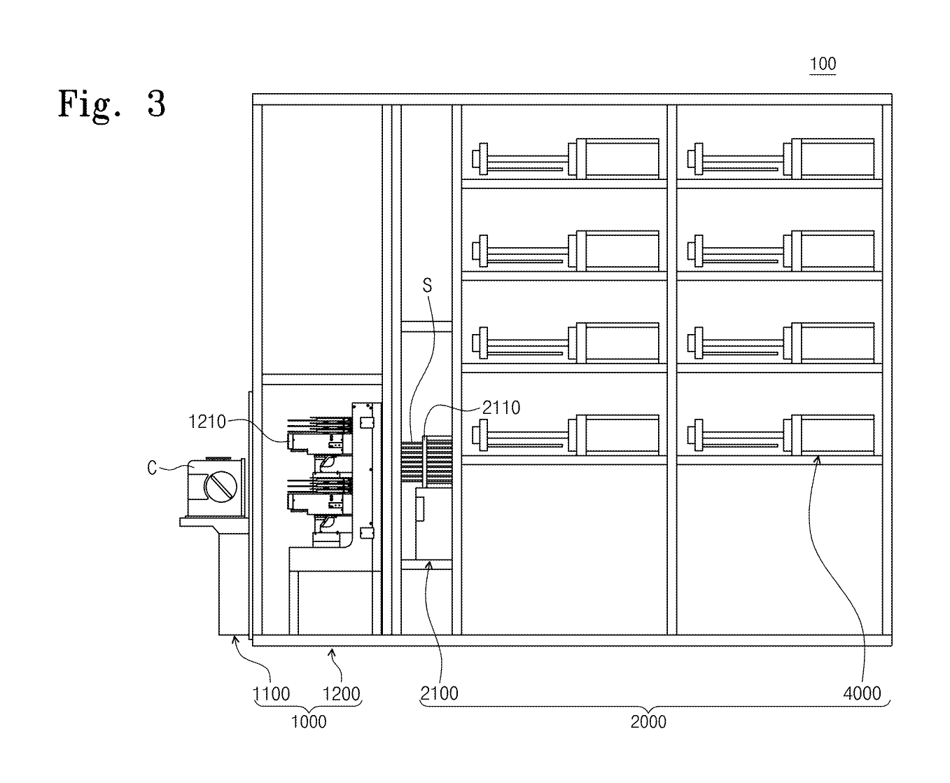

FIG. 2 is a plan view illustrating the substrate treating apparatus 100 according to an embodiment of the present invention, and FIG. 3 is a sectional view illustrating the substrate treating apparatus 100 according to an embodiment of the present invention.

Referring to FIGS. 2 and 3, the substrate treating apparatus 100 includes an index module 1000 and a process module 2000.

The index module 1000 may receive substrates (S) from an external apparatus and carry the substrates (S) to the process module 2000, and the process module 2000 may perform a supercritical drying process.

The index module 1000 is an equipment front end module (EFEM) and includes load ports 1100 and a transfer frame 1200.

Containers (C) in which substrates (S) are stored are placed on the load ports 1100. Front opening unified pods (FOUPs) may be used as containers (C). Containers (C) may be carried to the load ports 1100 from an outside area or carried from the load ports 1100 to an outside area via an overhead transfer (OHT).

The transfer frame 1200 carries substrates (S) between the containers (C) placed on the load ports 1100 and the process module 2000. The transfer frame 1200 includes an index robot 1210 and an index rail 1220. The index robot 1210 may carry a substrate (S) while moving on the index rail 1220.

The process module 2000 is a module in which processes are actually performed. The process module 2000 includes a buffer chamber 2100, a transfer chamber 2200, a first process chamber 3000, and a second process chamber 4000.

A substrate (S) is temporarily stored in the buffer chamber 2100 while being carried between the index module 1000 and the process module 2000. A buffer slot may be formed in the buffer chamber 2100 to place a substrate (S) therein. For example, the index robot 1210 may pick up a substrate (S) from a container (C) and place the substrate (S) in the buffer slot, and a transfer robot 2210 of the transfer chamber 2200 may pick up the substrate (S) from the buffer slot and transfer the substrate (S) to the first process chamber 3000 or the second process chamber 4000. A plurality of buffer slots may be formed in the buffer chamber 2100 so that a plurality of substrates (S) can be placed in the buffer chamber 2100.

A substrate (S) is carried among the buffer chamber 2100, the first process chamber 3000, and the second process chamber 4000 through the transfer chamber 2200. The transfer chamber 2200 may include the transfer robot 2210 and a transfer rail 2220. The transfer robot 2210 may carry a substrate (S) while moving on the transfer rail 2220.

The first process chamber 3000 and the second process chamber 4000 may be used to perform a cleaning process.

Procedures of a cleaning process may be sequentially performed in the first process chamber 3000 and the second process chamber 4000. For example, a chemical process, a rinsing process, and an organic solvent process of a cleaning process may be performed in the first process chamber 3000, and a supercritical drying process of the cleaning process may be performed in the second process chamber 4000.

The first process chamber 3000 and the second process chamber 4000 are disposed on sides of the transfer chamber 2200. For example, the first process chamber 3000 and the second process chamber 4000 may face each other with the transfer chamber 2200 being disposed therebetween.

The process module 2000 may include a plurality of first process chambers 3000 and a plurality of second process chambers 4000. In this case, the first process chambers 3000 and the second process chambers 4000 may be arranged in lines along sides of the transfer chamber 2200 or may be vertically stacked at sides of the transfer chamber 2200. In addition, the first process chambers 3000 and the second process chambers 4000 may be arranged in a combination of the above-mentioned manners.

Arrangement of the first process chambers 3000 and the second process chambers 4000 is not limited to the above-mentioned manner. That is, the first process chambers 3000 and the second process chambers 4000 may be arranged in various manners in consideration of the footprint or processing efficiency of the substrate treating apparatus 100.

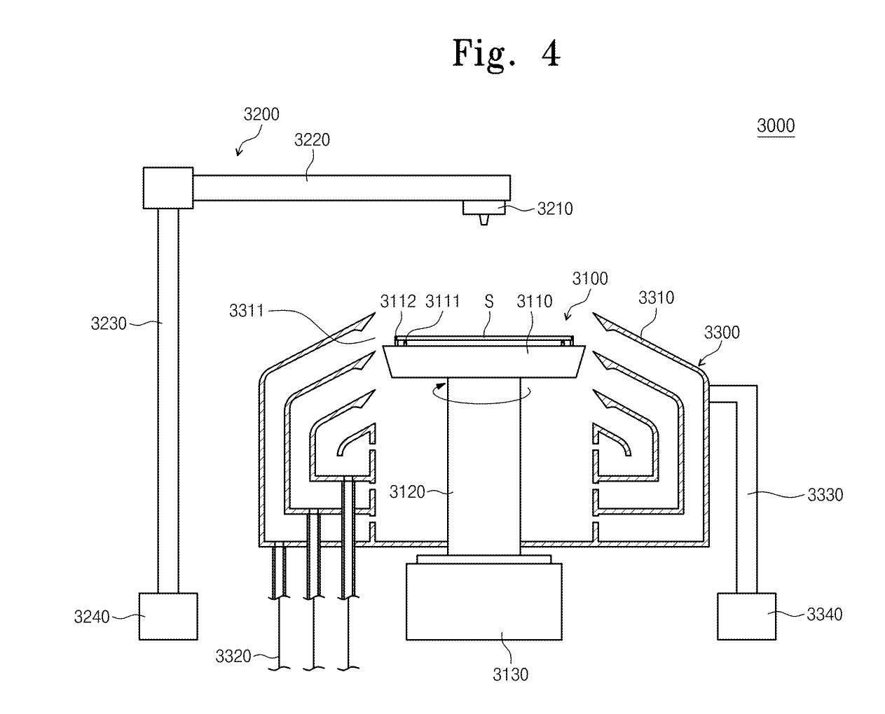

Hereinafter, the first process chamber 3000 will be described in detail. FIG. 4 is a sectional view illustrating the first process chamber 3000 depicted in FIG. 2.

The first process chamber 3000 may be used to perform a chemical process, a rinsing process, and an organic solvent process. Alternatively, the first process chamber 3000 may be used to perform some of such processes. The chemical process may be performed to remove contaminants from a substrate (S) by applying a detergent to the substrate (S), the rinsing process may be performed to remove the detergent remaining on the substrate (S) by applying a rinsing agent to the substrate (S), and the organic solvent process may be performed to replace a rinsing agent remaining between circuit patterns of the substrate (S) with an organic solvent having low surface tension.

Referring to FIG. 4, the first process chamber 3000 includes a support member 3100, a nozzle member 3200, and a collecting member 3300.

The support member 3100 may support a substrate (S) and rotate the substrate (S).

The support member 3100 may include a support plate 3110, support pins 3111, chucking pins 3112, a rotation shaft 3120, and a rotary actuator 3130.

The support plate 3110 has a top surface shaped like a substrate (S), and the support pins 3111 and the chucking pins 3112 are provided on the top surface of the support plate 3110.

The support pins 3111 may support a substrate (S), and the chucking pins 3112 may hold the substrate (S) firmly.

The rotation shaft 3120 is connected to the bottom side of the support plate 3110. The rotation shaft 3120 receives rotation power from the rotary actuator 3130 and rotates the support plate 3110. Thus, a substrate (S) placed on the support plate 3110 can be rotated. At this time, the chucking pins 3112 prevent the substrate (S) from departing from a set position.

The nozzle member 3200 injects a chemical to the substrate (S). The nozzle member 3200 includes a nozzle 3210, a nozzle bar 3220, a nozzle shaft 3230, and a nozzle shaft actuator 3240.

The nozzle 3210 is used to inject a chemical to the substrate (S) placed on the support plate 3110. The chemical may be a detergent, a rinsing agent, or an organic solvent. Examples of the detergent may include: a hydrogen peroxide (H₂O₂) solution; a solution prepared by mixing a hydrogen peroxide solution with ammonia (NH₄OH), hydrochloric acid (HCl), or sulfuric acid (H₂SO₄); and a hydrofluoric acid (HC) solution. The rinsing agent may be pure water. Examples of the organic solvent may include: isopropyl alcohol, ethyl glycol, 1-propanol, tetrahydrofuran, 4-hydroxy-4-methyl-2-pentanone, 1-butanol, 2-butanol, methanol, ethanol, n-propyl alcohol, and dimethyl ether. Such organic solvents may be used in the form of a solution or gas.

The nozzle 3210 is provided on a lower side of an end of the nozzle bar 3220. The nozzle bar 3220 is coupled to the nozzle shaft 3230, and the nozzle shaft 3230 can be lifted or rotated. The nozzle shaft actuator 3240 may lift or rotate the nozzle shaft 3230 to adjust the position of the nozzle 3210.

The collecting member 3300 collects a supplied chemical. If a chemical is supplied to the substrate (S) through the nozzle member 3200, the support member 3100 may rotate the substrate (S) so as to distribute the chemical uniformly to the entire area of the substrate (S). When the substrate (S) is rotated, the chemical may scatter from the substrate (S). The collecting member 3300 collects the chemical scattering from the substrate (S).

The collecting member 3300 may include a collecting vessel 3310, a collecting line 3320, a lift bar 3330, and a lift actuator 3340.

The collecting vessel 3310 has a ring shape surrounding the support plate 3110.

A plurality of collecting vessels 3310 may be provided. In this case, the collecting vessels 3310 may have ring shapes surrounding the support plate 3110 and sequentially spaced apart from the support plate 3110 when viewed from the topside. The more distant the collecting vessel 3310 is from the supporting plate 3110, the higher the collecting vessel 3310 is. Collecting slots 3311 are formed between the collecting vessels 3310 to receive a chemical scattering from the substrate (S).

The collecting line 3320 is formed on the bottom side of the collecting vessel 3310. A chemical collected in the collecting vessel 3310 is supplied to a chemical recycling system (not shown) through the collecting line 3320.

The lift bar 3330 is connected to the collecting vessel 3310 to receive power from the lift actuator 3340 and move the collecting vessel 3310 vertically. If a plurality of collecting vessels 3310 are provided, the lift bar 3330 may be connected to the outermost collecting vessel 3310. The lift actuator 3340 may lift or lower the collecting vessels 3310 using the lift bar 3330 so as to adjust the position of one of the collecting slots 3311 when a scattering chemical is collected through the one of the collecting slots 3311.

Hereinafter, the second process chamber 4000 will be described in detail.

The second process chamber 4000 may be used to perform a supercritical drying process using a supercritical fluid. As described above, the second process chamber 4000 may be used to perform other processes as well as a supercritical drying process. In addition, the second process chamber 4000 may be used to perform a process using a process fluid other than a supercritical fluid.

Hereinafter, the second process chamber 4000 will be described in detail according to an embodiment of the present invention.

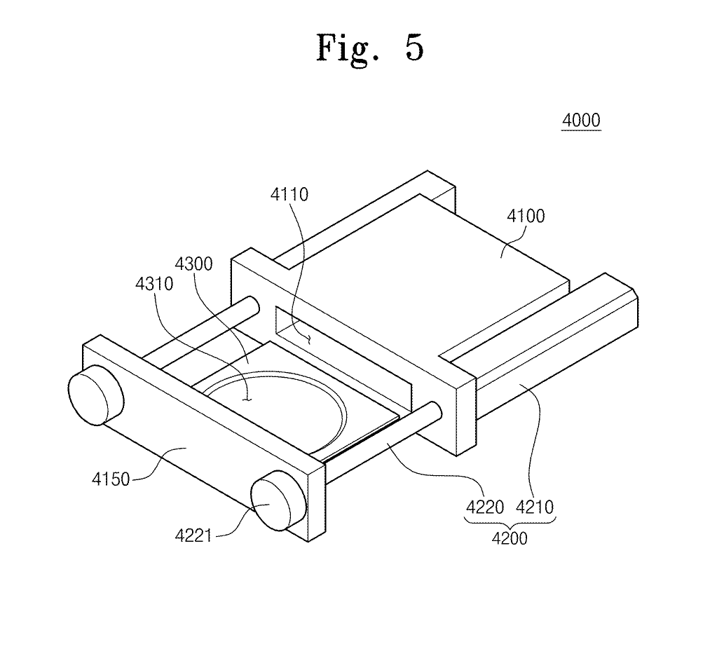

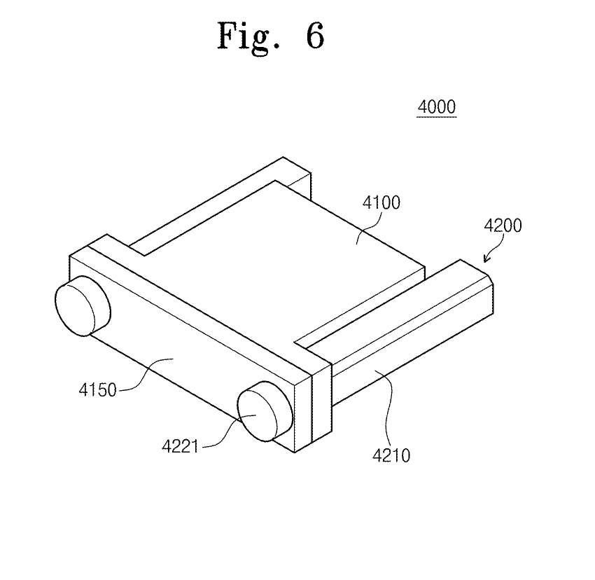

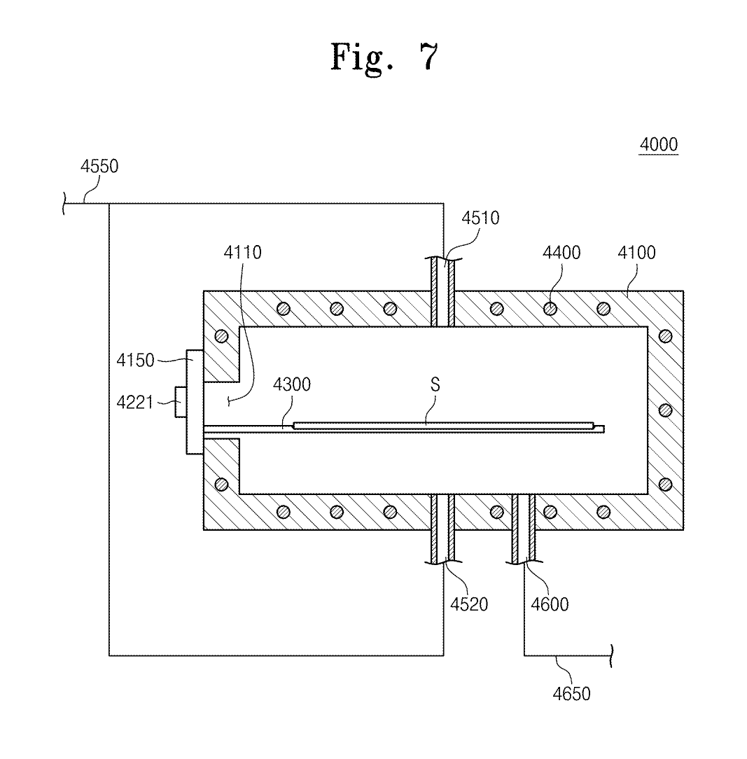

FIGS. 5 and 6 are perspective views illustrating an example of the second process chamber 4000 depicted in FIG. 2, and FIG. 7 is a sectional view illustrating the second process chamber 4000 depicted in FIG. 2.

Referring to FIGS. 5 through 7, the second process chamber 4000 may include a housing 4100, a door 4150, pressing members 4200, a support member 4300, a heating member 4400, supply ports 4500, and an exhaust port 4600.

The housing 4100 provides a space in which a supercritical drying process can be performed. The housing 4100 is formed of a material resistant to high pressures equal to or higher than a critical pressure.

An entrance may be formed in a side of the housing 4100. A substrate (S) may be carried into or out of the housing 4100 through the entrance 4110. A substrate (S) on which an organic solvent remains after an organic solvent process performed in the first process chamber 3000 may be carried into the housing 4100.

When viewed from the topside, a side of the housing 4100 in which the entrance 4110 is formed may be perpendicular to a side of the transfer chamber 2200 on which the second process chamber 4000 is disposed. If the transfer robot 2210 of the transfer chamber 2200 moves into the housing 4100 to carry a substrate (S) into the housing 4100, the entrance 4110 has to be formed in a side of the housing 4100 facing the transfer chamber 2200. However, according to the present invention, since the support member 4300 on which the transfer robot 2210 places a substrate (S) can be placed outside the housing 4100, the entrance 4110 can be formed in a side of the housing 4100 perpendicular to the transfer chamber 2200 instead of being formed in a side of the housing 4100 facing the transfer chamber 2200.

The door 4150 may be used to close or open the entrance 4110. The door 4150 may face the side of the housing 4100 in which the entrance 4110 is formed and may be moved in a direction perpendicular to the side of the housing 4100 to close or open the entrance 4110. In this way, the housing 4100 or the second process chamber 4000 can be closed or opened.

The pressing members 4200 may apply forces to the door 4150. The pressing members 4200 may move the door 4150 away or toward the entrance 4110. For example, the pressing members 4200 may apply forces to the door 4150 in a direction perpendicular to the side of the housing 4100 in which the entrance 4110 is formed, so as to move the door 4150.

In addition, during a supercritical drying process, the pressing members 4200 may apply forces to the door 4150 against the entrance 4110 so as to keep the housing 4100 in a closed state. Since a supercritical drying process is performed at a high pressure in a supercritical state, during the supercritical drying process, the door 4150 is pushed away from the door 4150 due to a pressure difference between the inside and outside of the housing 4100. However, the pressing members 4200 push the door 4150 with a larger force in an opposite direction so that the housing 4100 can be kept close during the supercritical drying process.

The pressing members 4200 may include cylinders 4210 and rods 4220. The cylinders 4210 may be disposed at both sides of the housing 4100. Ends of the rods 4220 may be connected to the cylinders 4210, and the other ends of the rods 4220 may be coupled to the door 4150. For example, ends of the rods 4220 may be inserted in the cylinders 4210, and the rods 4220 may be inserted through the housing 4100 and the door 4150. Rod heads 4221 larger than portions of the rods 4220 inserted through the door 4150 may be formed on the other ends of the rods 4220. The rod heads 4221 may be in tight contact with a side of the door 4150 opposite to the entrance 4110.

In this structure, the rods 4220 may be moved by the cylinders 4210 in a direction perpendicular to the side of the housing 4100 in which the entrance 4110 is formed, so as to move the door 4150 horizontally. In this way, the door 4150 may be used to close or open the entrance 4110. In addition, the door 4150 may be brought into contact with the entrance 4110 and pushed against the housing 4100 by the rod heads 4221 to keep the housing 4100 in a closed state during a process.

The support member 4300 supports a substrate (S). The support member 4300 may support an edge region of a substrate (S). For example, the support member 4300 may have a plate shape in which a hole 4310 is formed. The hole 4310 may have a shape equal to or similar to the shape of a substrate (S) and a size smaller than the substrate (S). If a substrate (S) is placed on the support member 4300, the topside and bottom side of the substrate (S) may be exposed owing to the hole 4310 formed in the support member 4300. Thus, during a supercritical drying process in the second process chamber 4000, the entirety of the substrate (S) may be exposed to a supercritical fluid.

The support member 4300 may be disposed on a side of the door 4150 facing the entrance 4110. The support member 4300 disposed on the door 4150 may be slid into or out of the housing 4100 through the entrance 4110 as the door 4150 is moved. The support member 4300 may have a plate shape which has a side fixed to the side of the door 4150 facing the entrance 4110 and extends in a direction perpendicular to the side of the door 4150. However, the installation position of the support member 4300 is not limited to the door 4150. For example, the support member 4300 may be installed on the inside of the housing 4100.

The entrance 4110 may have the same shape as the side shape of the support member 4300 or may be slightly greater than the side of the housing 4100 so that the support member 4300 can be moved into the housing 4100 through the entrance 4110. Since the inside of the housing 4100 is kept at a high pressure equal to or greater than a critical pressure during a supercritical drying process, a force necessary to close the housing 4100 with the door 4150 is proportional to the size of the entrance 4110. Thus, the size of the entrance 4110 may be adjusted close to the side area of the support member 4300 to reduce a force necessary to close the housing 4100.

The heating member 4400 is used to heat the inside of the housing 4100. The heating member 4400 may heat a supercritical fluid supplied into the second process chamber 4000 to a critical temperature or higher so as to maintain the supercritical fluid at a supercritical state or return the supercritical fluid into the supercritical state if the supercritical fluid liquefies. The cylinders 4210 may be buried in a wall of the housing 4100. For example, a heater configured to generate heat from electricity received from an external power source may be used as the heating member 4400.

The supply ports 4500 supply a supercritical fluid to the second process chamber 4000. The supply ports 4500 may be connected to a supply line 4550 to supply a supercritical fluid. A valve may be disposed at the supply ports 4500 to control the flow rate of a supercritical fluid supplied from the supply line 4550.

The supply ports 4500 may be include an upper supply port 4510 and a lower supply port 4520. The upper supply port 4510 is disposed in an upper wall of the housing 4100 to supply a supercritical fluid to the top side of a substrate (S) supported on the support member 4300. The lower supply port 4520 is disposed in a lower wall of the housing 4100 to supply a supercritical fluid to the rear side of the substrate (S) placed on the support member 4300. The top side of the substrate (S) may be a patterned side, and the rear side of the substrate (S) may be a non-patterned side.

The supply ports 4500 (the upper supply port 4510 and the lower supply port 4520) may supply a supercritical fluid to center regions of the substrate (S). For example, the upper supply port 4510 may be located above the substrate (S) supported on the support member 4300 and aligned with the center of the substrate (S). For example, the lower supply port 4520 may be located under the substrate (S) supported on the support member 4300 and aligned with the center of the substrate (S). Then, a supercritical fluid supplied through the supply ports 4500 can be uniformly distributed to the entirety of the substrate (S) while the supercritical fluid reaches the center regions of the substrate (S) and spreads to the edge regions of the substrate (S).

A supercritical fluid may be supplied through the lower supply port 4520 and then the upper supply port 4510. In an early stage of a supercritical drying process, the inside pressure of the second process chamber 4000 may be lower than a critical pressure, and thus a supercritical fluid supplied into the second process chamber 4000 may be liquefied. Therefore, if a supercritical fluid is supplied through the upper supply port 4510 in an early stage of a supercritical drying process, the supercritical fluid may liquefy and fall to the substrate (S) by gravity to damage the substrate (S). A supercritical fluid may be supplied through the upper supply port 4510 after the supercritical fluid is supplied into the second process chamber 4000 through the lower supply port 4520 and the inside pressure of the second process chamber 4000 reaches a critical pressure, so as to prevent the supercritical fluid from liquefying and falling to the substrate (S).

The exhaust port 4600 discharges a supercritical fluid from the second process chamber 4000. The exhaust port 4600 may be connected to an exhaust line 4650 to discharge a supercritical fluid. A valve may be disposed at the exhaust port 4600 to control the flow rate of a supercritical fluid to be discharged through the exhaust line 4650. A supercritical fluid may be discharged to the atmosphere or a supercritical fluid recycling system (not shown).

The exhaust port 4600 may be formed in a lower wall of the housing 4100. In a late stage of a supercritical drying process, the inside pressure of the second process chamber 4000 may be reduced to a value lower than a critical pressure as a supercritical fluid is discharged from the second process chamber 4000, and thus a supercritical fluid filled in the second process chamber 4000 may be liquefied. The liquefied supercritical fluid may flow to the exhaust port 4600 formed in the lower wall of the housing 4100 by gravity and then flow to the outside through the exhaust port 4600.

In the second process chamber 4000, the inside and outside temperatures of the housing 4100 are different. Thus, when a substrate (S) placed on the support member 4300 is carried into the housing 4100, the substrate (S) may be damaged because of the inside and outside temperature difference of the housing 4100.

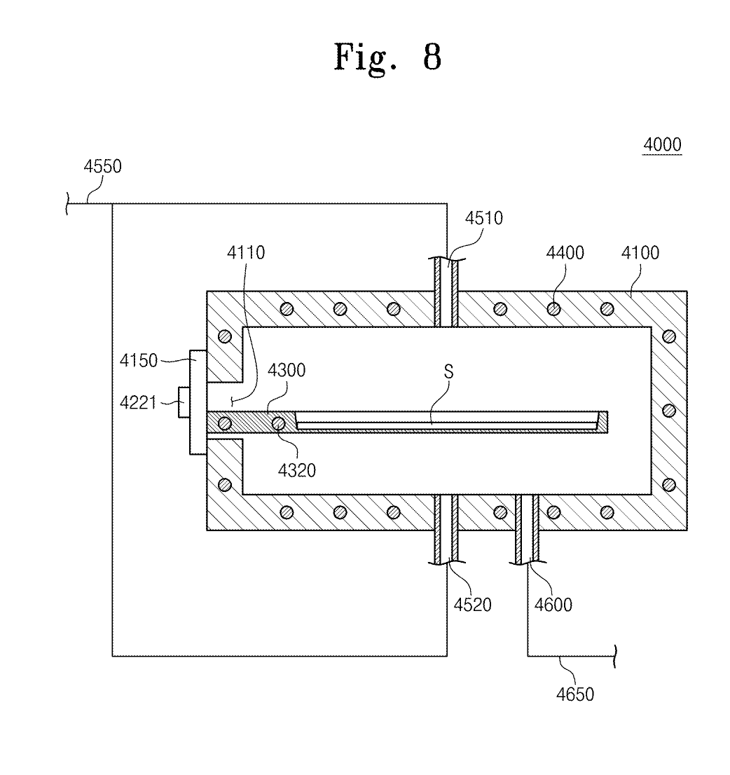

FIG. 8 is a sectional view illustrating a modification example of the second process chamber 4000 depicted in FIG. 2.

Referring to FIG. 8, the second process chamber 4000 may further include a heating member 4320. The heating member 4320 may be used to heat a substrate (S) placed on the support member 4300.

The heating member 4320 may be disposed in the support member 4300 to heat a substrate (S) placed on the support member 4300. For example, as shown in FIG. 8, the heating member 4320 may be a heater buried in the support member 4300. The heater may generate heat using an external power source to increase the temperature of the support member 4300. In this way, a substrate (S) placed on the support member 4300 may be kept at a predetermined temperature.

Alternatively, the heating member 4320 may be disposed at the door 4150. For example, the heating member 4320 may be a heater buried in the door 4150. Heat generated from the heater may be transferred to the support member 4300 disposed on the door 4150. In this way, a substrate (S) placed on the support member 4300 may be kept at a predetermined temperature.

While a supercritical drying process is performed in the housing 4100 of the second process chamber 4000, the heating member 4400 heats the inside of the housing 4100 to keep the inside of the housing 4100 at a high temperature equal to or greater than a critical temperature. Since the heating member 4320 heats a substrate (S) placed on the support member 4300 to keep the substrate (S) at a predetermined temperature when the support member 4300 is placed outside the housing 4100 after the door 4150 is moved away from the entrance 4110, the substrate (S) is less varied in temperature while being carried out of the housing 4100, and thus the substrate (S) may not be damaged by a temperature difference.

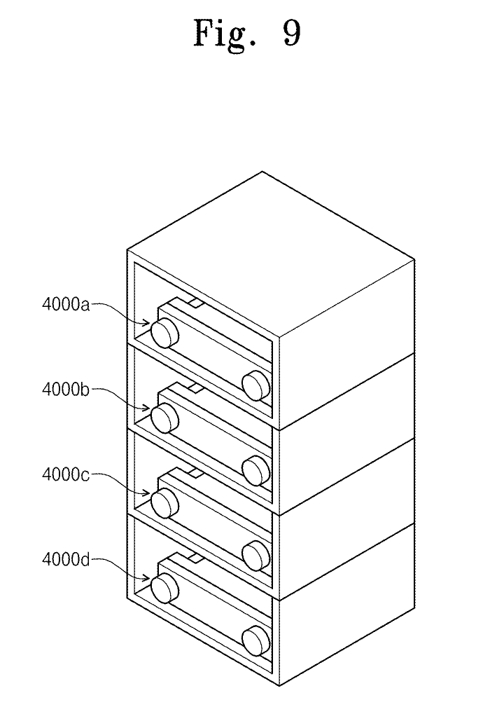

FIG. 9 illustrates a stacked state of second process chambers 4000 such as the second process chamber 4000 shown in FIG. 2.

Referring to FIG. 9, four second process chambers 4000a, 4000b, 4000c, and 4000d are vertically stacked. The number of the second process chambers 4000 may be varied. Support members 4300 are provided on doors 4150 of the second process chambers 4000, and substrates (S) placed on the support members 4300 are carried into housings 4100 by sliding the doors 4150 through entrances 4110 of the housings 4100. Thus, it is unnecessary for the transfer robot 2210 to move into the housing 4100 to place a substrate (S) in the housing 4100. Thus the heights of the second process chambers 4000 can be small. In addition, since the sizes of the entrances 4110 are small owing to this structure, the entrances 4110 can be kept in a closed state with less forces during a supercritical drying process. That is, small pressing members 4200 having low power can be used to close the housings 4100. As a result, the sizes of the second process chambers 4000 for performing a supercritical drying process can be reduced. Particularly, the heights of the second process chambers 4000 can be reduced. Therefore, the second process chambers 4000 can be easily stacked.

While the present invention has been explained for the case where substrate treating apparatus 100 treats a substrate (S) using a supercritical fluid, the substrate treating apparatus 100 of the present invention is not limited to performing a supercritical process. For example, the substrate treating apparatus 100 may be used to treat a substrate (S) by supplying a different process fluid into the second process chamber 4000 through the supply ports 4500 instead of supplying a supercritical fluid. For example, organic solvents, gases having various ingredients, plasma gases, or inert gases may be used instead of a supercritical fluid.

In addition, the substrate treating apparatus 100 may further include a controller for controlling elements of the substrate treating apparatus 100. For example, the controller may control the heating member 4400 to adjust the inside temperature of the housing 4100. In another example, the controller may control valves disposed at the nozzle member 3200, the supply line 4550, and the exhaust line 4650 to adjust the flow rates of a chemical or supercritical fluid. In another example, the controller may control the pressing members 4200 to open or close the housing 4100. In another example, under the control of the controller, a supercritical fluid may be supplied through one of the upper supply port 4510 and the lower supply port 4520, and if the inside pressure of the second process chamber 4000 reaches a preset value, the supercritical fluid may be supplied through the other of the upper supply port 4510 and the lower supply port 4520.

The controller may be hardware, software, or a device such as computer provided as a combination of hardware and software.

For example, the controller may be hardware such as ASICs (application specific integrated circuits), DSPs (digital signal processors), DSPDs (digital signal processing devices), PLDs (programmable logic devices), FPGAs (field programmable gate arrays), processors, micro-controllers, microprocessors, and electric devices having similar control functions.

For example, the controller may be software such as a software code or application written in at least one programming language. Software may be executed by a controller provided in the form of hardware. Alternatively, software may be transmitted from an external device such as a server to a controller provided in the formed of hardware and may be installed on the controller.

Hereinafter, a substrate treating method will be explained using the substrate treating apparatus 100 according to an embodiment of the present invention. Although the substrate treating method is explained using the substrate treating apparatus 100 in the following description, the substrate treating method may be performed using another apparatus similar to the substrate treating apparatus 100. In addition, the substrate treating method of the present invention may be stored in a computer-readable recording medium in the form of an executable code or program.

Hereinafter, an embodiment of the substrate treating method of the present invention will be explained. The embodiment relates to a cleaning process in general.

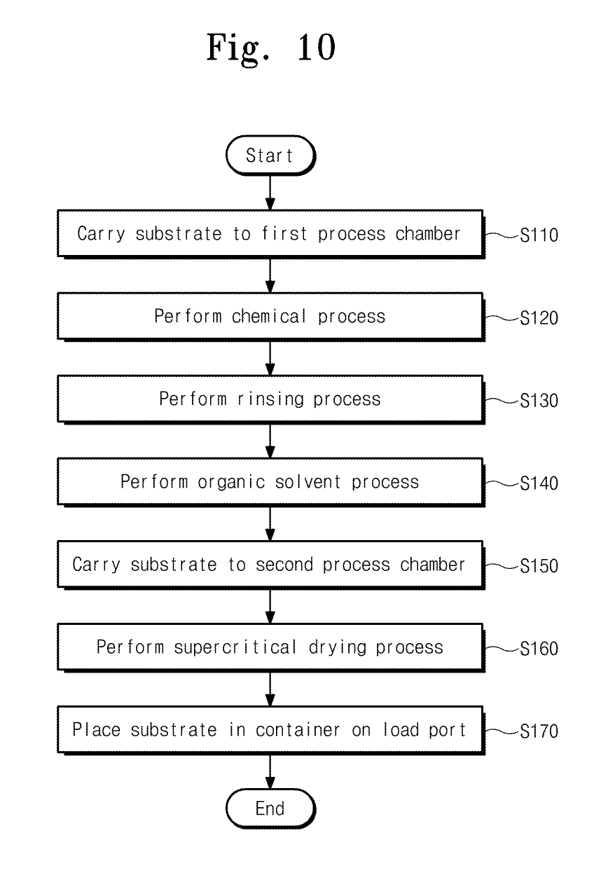

FIG. 10 is a flowchart for explaining a substrate treating method according to an embodiment of the present invention.

The substrate treating method of the current embodiment includes: operation S110 in which a substrate (S) is carried into the first process chamber 3000; operation S120 in which a chemical process is performed; operation S130 in which a rinsing process is performed; operation S140 in which an organic solvent process is performed; operation S150 in which the substrate (S) is carried to a second process chamber 4000; operation S160 in which a supercritical drying process is performed; and operation S170 in which the substrate (S) is put in a container (C) placed in a load port 1100. The above-listed operations are not required to be performed in the listed order. For example, an operation listed later may be performed prior to an operation listed first. This is equal in another embodiment of the substrate treating method. The operations will now be explained in detail.

A substrate (S) is carried into the first process chamber 3000 (S110).

First, a container in which substrates (S) are stored is placed on the load port 1100 by a carrying device such as an OHT. Then, the index robot 1210 picks up a substrate (S) from the container and places the substrate (S) in a buffer slot. The transfer robot 2210 picks up the substrate (S) from the buffer slot and carries the substrate (S) into the first process chamber 3000. The substrate (S) is placed on the support plate 3110 in the first process chamber 3000.

Thereafter, a chemical process is performed (S120). After the substrate (S) is placed on the support plate 3110, the nozzle shaft 3230 is moved and rotated by the nozzle shaft actuator 3240 to place the nozzle 3210 directly above the substrate (S). A detergent is injected to the top side of the substrate (S) through the nozzle 3210. Contaminants are removed from the substrate (S) as the detergent is injected. At this time, the rotary actuator 3130 rotates the rotation shaft 3120 to rotate the substrate (S). As the substrate (S) is rotated, the detergent can be uniformly supplied to the substrate (S) although the detergent scatters from the substrate (S). The detergent scattering from the substrate (S) is collected in the collecting vessels 3310 where the detergent is discharged to a fluid recycling system (not shown) through the collecting line 3320. At this time, the lift actuator 3340 lifts or lowers the collecting vessels 3310 so that the scattering detergent can be collected in one of the collecting vessels 3310.

After contaminants are removed from the substrate (S), a rinsing process is performed (S130). After the chemical process performed to remove contaminants from the substrate (S), the detergent remains on the substrate (S). The nozzle 3210 through which the detergent is injected is moved away from the topside of the substrate (S), and another nozzle 3210 is moved to a position directly above the substrate (S) to inject a rinsing agent to the topside of the substrate (S). The rinsing agent supplied to the substrate (S) cleans the detergent remaining on the substrate (S). During the rinsing process, the substrate (S) may be rotated, and a chemical may be collected. The lift actuator 3340 adjusts the height of the collecting vessels 3310 so that the rinsing agent can be collected in one of the collecting vessels 3310 different from that used to collect the detergent.

After the substrate (S) is sufficiently washed, an organic solvent process is performed (S140). After the rinsing process, another nozzle 3210 is moved to a position directly above the substrate (S) to inject an organic solvent to the substrate (S). The rinsing agent remaining on the substrate (S) is replaced with the organic solvent. In the organic solvent process, the substrate (S) may not be rotated or may be rotated at low speed. The reason for this is that if the organic solvent evaporates soon, the surface tension of the organic solvent may cause interfacial tension between circuit patterns of the substrate (S) to make the circuit patterns collapse.

After the organic solvent process in the first process chamber 3000, the substrate (S) is carried to the inside of the second process chamber 4000 (S150), and a supercritical drying process is performed in the second process chamber 4000 (S160). The operations S150 and S160 will be explained later in more detail when another embodiment of the substrate treating method is explained.

After the supercritical drying process, the substrate (S) is carried into the container placed on the load port 1100 (S170). The second process chamber 4000 is opened, and the transfer robot 2210 picks up the substrate (S). The substrate (S) may be carried to the buffer chamber 2100 by the transfer robot 2210, and the index robot 1210 may carry the substrate (S) from the buffer chamber 2100 to the container (C).

Hereinafter, another embodiment of the substrate treating method of the present invention will be explained. The other embodiment of the substrate treating method relates to a supercritical drying process in the second process chamber 4000.

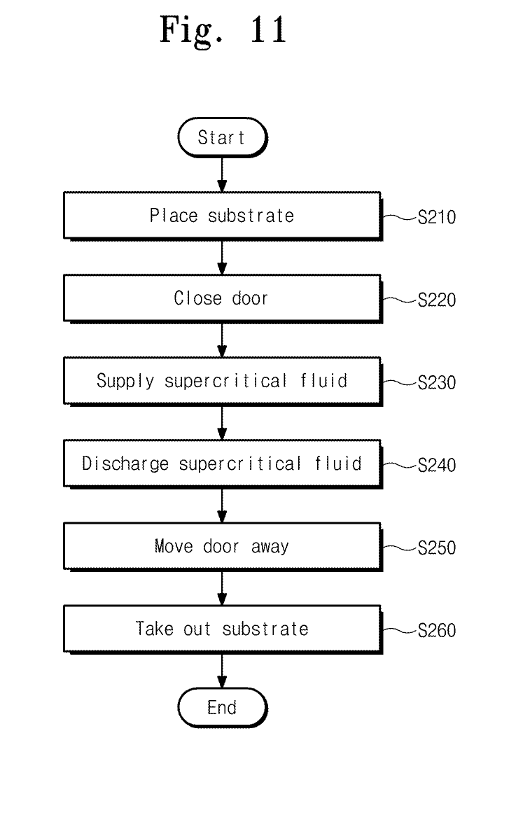

FIG. 11 is a flowchart for explaining another embodiment of the substrate treating method.

The substrate treating method of the other embodiment includes: operation S210 in which a substrate (S) is placed on the support member 4300 of the second process chamber 4000; operation S220 in which the door 4150 is pushed against the entrance 4110; operation S230 in which a supercritical fluid is supplied; operation S240 in which the supercritical fluid is discharged; operation S250 in which the door 4150 is moved away from the entrance 4110; and operation S260 in which the substrate (S) is carried out of the second process chamber 4000. The operations will now be explained in detail.

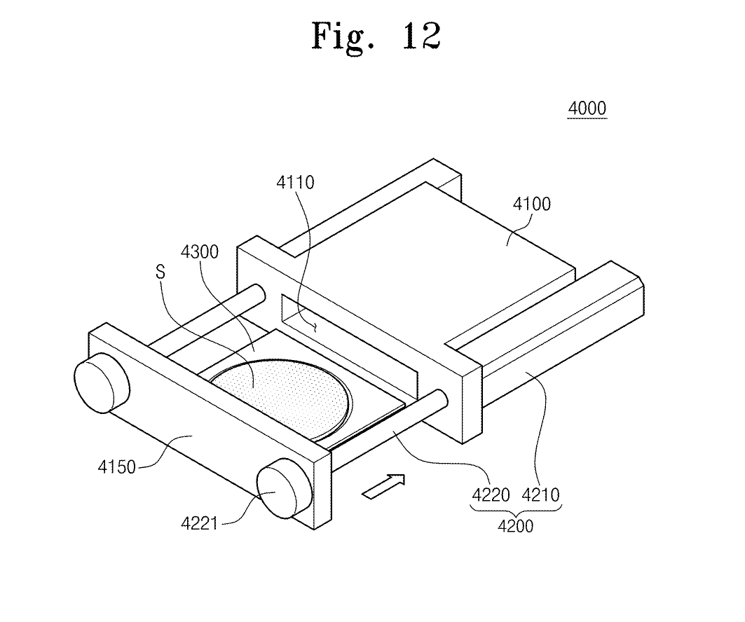

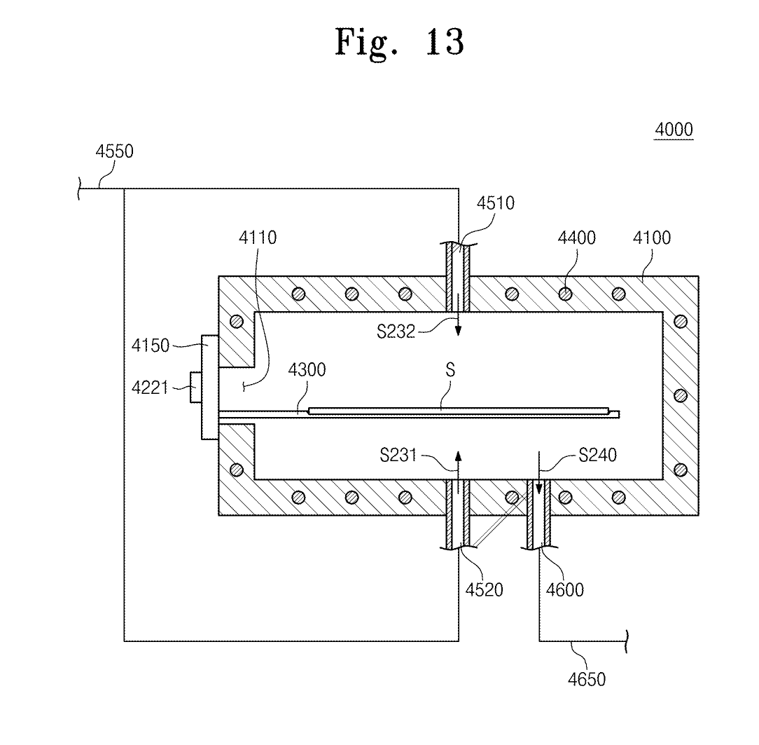

FIGS. 12 and 13 are views for explaining the substrate treating method of FIG. 11.

Referring to FIG. 12, a substrate (S) is placed on the support member 4300 of the second process chamber 4000 (S210). In the second process chamber 4000, the door 4150 is moved away from the entrance 4110, and thus the support member 4300 is placed outside the housing 4100. Therefore, the transfer robot 2210 is not necessary to move into the housing 4100 to place the substrate (S) on the support member 4300 because the support member 4300 is placed outside the housing 4100. The transfer robot 2210 may pick up the substrate (S) from the first process chamber 3000 in a state where an organic solvent remains on the substrate (S), and may place the substrate (S) on the support member 4300.

The door 4150 is pushed against the entrance 4110 (S220). After the substrate (S) is placed on the support member 4300, the pressing members 4200 moves the door 4150 to the entrance 4110 and pushes the door 4150 against the entrance 4110. As the door 4150 is moved in this way, the support member 4300 disposed on the door 4150 is moved into the housing 4100, and thus the substrate (S) is placed in the housing 4100. In addition, as the door 4150 is pushed against the entrance 4110, the inside of the housing 4100 can be sealed. In detail, the cylinders 4210 move the rods 4220 in a direction from the door 4150 toward the housing 4100, and thus the door 4150 to which the rods 4220 are coupled are pushed against the entrance 4110.

After the second process chamber 4000 is closed, a supercritical fluid is supplied (S230). The supercritical fluid may be injected into the housing 4100 through the supply ports 4500. At this time, the support member 4300 heats the inside of the housing 4100 to keep the inside of the housing 4100 at a supercritical state. The injected supercritical fluid may be supplied to the substrate (S) so as to dissolve an organic solvent remaining on the substrate (S) and thus dry the substrate (S).

The supercritical fluid may be supplied through the upper supply port 4510 and the lower supply port 4520. At this time, the support member 4300 may be placed closer to the upper wall of the housing 4100 than the lower wall of the housing 4100. In the case where the topside of the substrate (S) is a patterned side and the rear side of the substrate (S) is a non-patterned side, if the support member 4300 is closer to the upper wall of the housing 4100, the supercritical fluid supplied through the upper supply port 4510 may be effectively supplied to the substrate (S). Then, the patterned side of the substrate (S) may be effectively dried. That is, an organic solvent remaining between circuit patterns of the substrate (S) may be effectively dried.

Referring to FIG. 13, the supercritical fluid may be supplied through the lower supply port 4520 (S231) and then through the upper supply port 4510 (S232). When the supercritical fluid is initially supplied, the inside pressure of the housing 4100 may be lower than a critical pressure, and thus the supercritical fluid may liquefy. If the supercritical fluid is supplied to a position above the topside of the substrate (S), the supercritical fluid may liquefy and fall to the topside of the substrate (S) by gravity to damage the substrate (S). Therefore, the supercritical fluid may first be supplied through the lower supply port 4520 and then through the upper supply port 4510.

If the supercritical fluid is continuously supplied through the lower supply port 4520, the inside pressure of the housing 4100 may become equal to or greater than a critical pressure, and if the inside of the housing 4100 is heated by the heating member 4400, the inside temperature of the housing 4100 may become equal to or greater than a critical temperature. Thus, the inside of the housing 4100 can be in a supercritical state. When the inside of the housing 4100 enters a supercritical state, the supercritical fluid may be supplied through the upper supply port 4510.

That is, under the control of the controller, the supercritical fluid may be supplied through the upper supply port 4510 when the inside pressure of the housing 4100 becomes equal to or greater than a critical pressure.

While the supercritical drying process is performed, the pressing members 4200 may push the door 4150 against the housing 4100 to keep the housing 4100 or the second process chamber 4000 in a closed state. If the cylinders 4210 may generate forces in a direction from the door 4150 to the housing 4100, the rod heads 4221 of the rods 4220 may apply forces to a side of the door 4150 opposite the entrance 4110 to push the door 4150 against the entrance 4110.

Since the inside of the housing 4100 is kept in a supercritical state, the inside pressure of the housing 4100 is kept at a high pressure greater than a critical pressure. Therefore, due to a pressure different between the inside and outside of the housing 4100, a force may be applied to a surface of the door 4150 facing the entrance 4110 to move the door 4150 away from the housing 4100. However, the housing 4100 can be kept in a closed state because the pressing members 4200 apply a force greater than the force caused by the pressure difference to the surface of the door 4150 opposite to the entrance 4110.

If the substrate (S) is sufficiently dried as the organic solvent remaining on the substrate (S) is dissolved in the supercritical fluid, the supercritical fluid is discharged (S240). The supercritical fluid is discharged from the second process chamber 4000 through the exhaust port 4600. Supply and discharge of the supercritical fluid may be controlled by adjusting the flow rates of the supercritical fluid in the supply line 4550 and the exhaust line 4650 by using the controller. The supercritical fluid may be discharged to the atmosphere or a supercritical fluid recycling system (not shown) through the exhaust line 4650.

If the inside pressure of the second process chamber 4000 is sufficiently reduced to, for example, atmospheric pressure after the supercritical fluid is discharged, the door 4150 is moved away from the entrance 4110 (S250). Specifically, the cylinders 4210 move the rods 4220 in a direction from the housing 4100 to the door 4150, and then the door 4150 connected to the rods 4220 is moved away from the entrance 4110.

The substrate (S) is carried out of the second process chamber 4000 (S280). When the door 4150 is moved away from the entrance 4110, the support member 4300 is placed outside the housing 4100. The transfer robot 2210 may pick up the substrate (S) from the support member 4300 placed outside of the housing 4100 and carry the substrate (S) out of the second process chamber 4000.

According to the present invention, the door is slidable in the process chamber, and thus the process chamber occupies less space in a vertical direction.

In addition, according to the present invention, the process chambers can be vertically stacked. That is, more process chambers can be disposed in the same foot print, and thus substrate processing efficiency can be improved.

In addition, according to the present invention, since the support member disposed on the door can be moved into and out of the housing, a substrate can be loaded and unloaded at a position outside the housing, and thus a device such as the transfer chamber is not required to move into the housing to carry a substrate so that the entrance of the housing can be small. If the size of the entrance is reduced, during a process, the housing can be kept in a closed state with a less force because a less force is generated by a pressure difference between the inside and outside of the housing and applied to the door through the entrance.

The effects of the present invention are not limited to the above-mentioned effects. Other effects of the present invention will be apparently understood by those skilled in the art through the following description and accompanying drawings.

The above-described embodiments are given so that those of skill in the related art could easily understand the present invention, and are not intended to limit the present invention.

Thus, the embodiments and elements thereof can be used in other ways or with known technology, and various modifications and changes in form and details can be made without departing from the scope of the present invention.

In addition, the scope of the present invention is defined by the following claims, and all differences within the scope will be considered as being included in the present invention.

What is claimed is:

1. An apparatus for treating a substrate, the apparatus comprising:
a housing comprising an entrance in a side thereof and providing a space for performing a process;
a door for opening and closing the entrance; and
a support member disposed on the door to receive a substrate thereon.

2. The apparatus of claim 1, further comprising a pressing member configured to apply a force to the door in a direction perpendicular to the side of the housing,
wherein the door is movable by the pressing member in the direction perpendicular to the side of the housing for closing or opening the housing.

3. The apparatus of claim 2, wherein the support member is placed in or outside the housing as the door is moved.

4. The apparatus of claim 3, wherein the pressing member comprises:
a cylinder coupled to the housing; and
a rod connected to the cylinder and the door, the rod being movable by the cylinder in the direction perpendicular to the side of the housing.

5. The apparatus of claim 3, wherein the support member has a plate shape extending from a side of the door facing the entrance in a direction in which the door is movable, and a hole is formed in the support member to receive the substrate.

6. The apparatus of claim 1, further comprising:
a heating member configured to heat an inside of the housing;
a supply port configured to supply a supercritical fluid to the housing; and
an exhaust port configured to discharge the supercritical fluid from the housing.

7. The apparatus of claim 6, wherein the supply port comprises:
an upper supply port disposed at an upper surface of the housing; and
a lower supply port disposed at a lower surface of the housing.

8. An apparatus for treating a substrate, the apparatus comprising:
a transfer chamber configured to transfer a substrate; and
a process chamber disposed at a side of the transfer chamber, the process chamber comprising a housing having an entrance in a side thereof and providing a space for performing a process, a door for opening and closing the entrance, and a support member disposed on the door to receive the substrate,
wherein when viewed from a topside, the side of the transfer chamber and the side of the housing are perpendicular.

9. The apparatus of claim 8, further comprising a pressing member configured to apply a force to the door in a direction perpendicular to the side of the housing,
wherein the door is movable by the pressing member in the direction perpendicular to the side of the housing for closing or opening the housing.

10. The apparatus of claim 9, wherein the pressing member comprises:
a cylinder coupled to the housing; and
a rod connected to the cylinder and the door, the rod being movable by the cylinder in the direction perpendicular to the side of the housing.

11. The apparatus of claim 9, wherein the support member has a plate shape extending from a side of the door facing the entrance in a direction in which the door is movable, and a hole is formed in the support member to receive the substrate.

12. The apparatus of claim 8, wherein the process chamber is provided in plurality, and
the plurality of process chambers are arranged in a line on the side of the transfer chamber along a direction in which the door is movable.

13. The apparatus of claim 8, wherein the process chamber is provided in plurality, and the plurality of process chambers are vertically stacked.

14. The apparatus of claim 8, further comprising:
a heating member configured to heat an inside of the housing;
a supply port configured to supply a supercritical fluid to the housing; and
an exhaust port configured to discharge the supercritical fluid from the housing.

15. The apparatus of claim 14, wherein the supply port comprises:
an upper supply port disposed at an upper surface of the housing; and
a lower supply port disposed at a lower surface of the housing.

16. A method for treating a substrate, the method comprising:
placing a substrate on a support member disposed on a door;
moving the door to a side of a housing in which an entrance is formed, so as to place the support member in the housing and close the housing;
performing a process on the substrate placed in the housing; and
moving the door away from the side of the housing so as to place the support member outside the housing and open the housing.

17. The method of claim 16, wherein in the moving of the door to and away from the side of the housing, a rod coupled to the door is moved in a direction perpendicular to the side of the housing by a cylinder connected to the rod and the housing.

18. The method of claim 16, wherein in the performing of the process, a force greater than a force generated by a pressure different between inner and outer sides of the housing is applied from a pressing member to the door so as to keep the housing in a closed state.

19. The method of claim 16, wherein the support member has a plate shape extending from a side of the door facing the entrance in a direction perpendicular to the side of the door, and a hole is formed in the support member to receive the substrate,
wherein in the performing of the process, a supercritical fluid is supplied to a topside and a rear side of the substrate through an upper supply port formed in an upper side of the housing and a lower supply port formed in a lower side of the housing.

20. The method of claim 19, wherein in the performing of the process, the supercritical fluid is supplied through the lower supply port before the supercritical fluid is supplied through the upper supply port.
